(19) United States
(12) Patent Application Publication
(10) Pub. No.: US 2006/0237873 A1
(43) Pub. Date: Oct. 26, 2006

(54) Housing for an air handling unit and method of manufacture thereof

(76) Inventor: Johannes Antonius Maria Reinders, PE Warnsveld (NL)

Correspondence Address: HOWREY LLP, C/O IP DOCKETING DEPARTMENT, 2941 FAIRVIEW PARK DR., SUITE 200, FALLS CHURCH, VA, 22042, US

(21) Appl. No.: 10/539,508

(22) PCT Filed: Dec. 18, 2003
(86) PCT No.: PCT/EP03/14574

§ 371 Date: Jun. 17, 2005

(30) Foreign Application Priority Data
Dec. 18, 2002 (NL) 1022199

(51) Int. Cl. B29C 47/00; B28B 1/02; F25D 19/00; F28D 5/00

(52) U.S. Cl. 264/310; 264/85; 62/298; 62/304

(57) ABSTRACT

The invention relates to an air handling unit comprising a housing defining an interior space and a heat exchange element located within the interior space. The housing is provided with an air inlet and an air outlet communicating an exterior of the housing with the interior space. According to the invention the housing is at least partially formed from plastics material using a rotomoulding technique.

The invention relates to a three-dimensional plastic housing or a part thereof for an air handling unit, for instance a heating device, a cooling device, a drying device, a humidifying device, an air-conditioner or the like. It further relates to method for manufacturing such a housing.

According to a known method the housing, optionally in components, is manufactured by making use of an injection moulding technique.

It is known from the injection moulding art that the products formed therewith are always subject to certain internal stresses. As result of the internal stresses, the impact resistance of the products in question leaves something to be desired. It is moreover never wholly possible to avoid the formed products having a seam.

A further drawback of the injection moulding art is that the manufacture of larger products is problematic. This is particularly a result of relatively high mould costs, which of course result in high product costs.

According to the present invention, there is provided an air handling unit comprising a housing defining an interior space and a heat exchange element located within the interior space, the housing being provided with an air inlet and an air outlet communicating an exterior of the housing with the interior space, wherein the housing is at least partially formed from plastics material using a rotomoulding technique. It has been found that by using a rotomoulding technique according to the present invention, an improved stress free and substantially seamless product can be achieved. This is in particular desirable for large housings of more than 15,000 litres where the cost of injection moulding would be very high, in particular when the number of items produced is low.

The invention also provides a method for manufacturing a three-dimensional plastic housing or a part thereof for an air handling unit, for instance a heating device, a cooling device, a drying device, a humidifying device, an air-conditioner or the like, wherein the housing is manufactured by rotomoulding in a mould to form a substantially hollow body.

A particularly advantageous form of rotomoulding comprises:

(a) designing the external form of the housing, optionally subdivided into its constituent parts;

(b) manufacturing a mould with a mould cavity having a form corresponding with said external form, respectively optionally more than one mould, which mould cavity is accessible for admitting plastic and can subsequently be closed, which mould consists of at least two parts such that the parts of the mould cavity bounded by these mould parts are all releasing;

(c) admitting into the mould cavity a limited quantity of plastic which has been plasticized in advance by heating and/or is plasticized on the heated wall of the mould cavity, which said limited quantity is sufficient to form a wall having at least approximately a chosen thickness;

(d) closing and then setting the mould into a rotating movement, optionally about more than one axis of rotation;

(e) cooling the wall of the mould cavity during said rotating movement, whereby the plastic plasticized by heating also solidifies on this wall through cooling and thus forms a layer of cured plastic gradually becoming thicker until all plastic introduced into the mould cavity has cured to form the housing for manufacturing, respectively a part thereof;

(f) opening the mould; and

(g) taking out the finished housing respectively a part thereof.

The housings, respectively their components, obtained with the method according to the invention are seamless and free of stress, whereby their impact resistance is very good.

The invention further provides a great variety of possible dimensions. Effective housing volumes of 1 litre to more than 15,000 litres can for instance be envisaged.

A great freedom of form and low investment costs are further realized. It is also easily possible to manufacture a plurality of colours within small series, since all the plastic introduced into the mould is after all converted without loss into finished product. In addition, the stated housings can be readily processed or post-processed.

The obtained products can advantageously be given a double-walled form, whereby the outside obtains an aesthetically attractive appearance, while the inside can be formed for technical purposes. Diverse components, such as a fan, a heat exchanger, a dewpoint cooler, electronic components or the like, can hereby be readily accommodated. Compared to the described prior art, the invention can thus result in a reduction in cost because fewer shell parts or filler pieces have to be manufactured in order to realize all required functions. This latter aspect also saves working time in processing or assembly, while the extra steps required according to the prior art can moreover be omitted, which reduces errors and losses.

In the case of a double-walled housing, the hollow space available in the housing can be used as air duct, for instance to draw in outside air to a fan. Pipes, cables and hoses can also be accommodated in the space in question. Colours as well as wall thicknesses can easily be chosen and changed or optimized.

In order to optimize the housing at the design stage, use can be made of a method of the described type, comprising the step of

(h) successively applying the method according to claim 1 at the design stage, wherein during step (c) different quantities of plastic are admitted each time into the mould cavity; and

(i) technically evaluating the thus obtained housings and choosing the best in accordance with chosen criteria for the definitive series production.

In a specific embodiment the method according to the invention is applied, comprising the step of

(j) performing step (c) with PP, PA, PE, and in particular LLDPE, as plastic.

The invention also relates to a three-dimensional plastic housing for an air handling unit, for instance a heating device, a cooling device, a drying device, a humidifying device, an air-conditioner or the like, manufactured by applying the method according to the above stated specifications.

An embodiments of the invention will now be explained in further detail by way of example only with reference to the accompanying figures, in which:

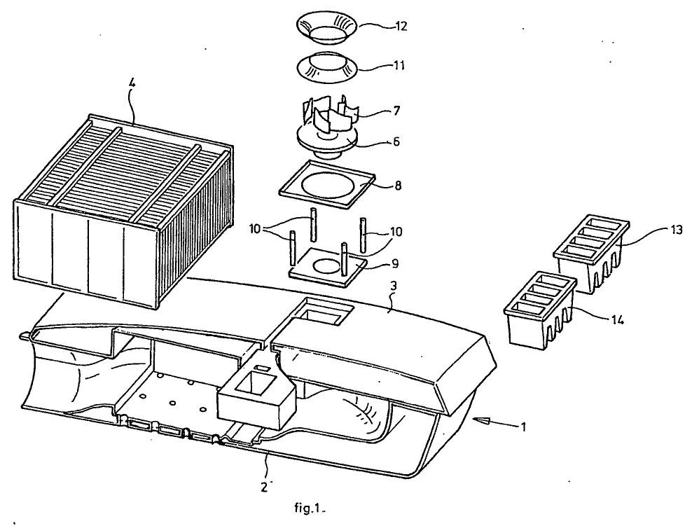

FIG. 1 shows a perspective view of one side of a housing that has been cut in half, wherein for the sake of clarity the components to be accommodated therein are drawn in exploded view;

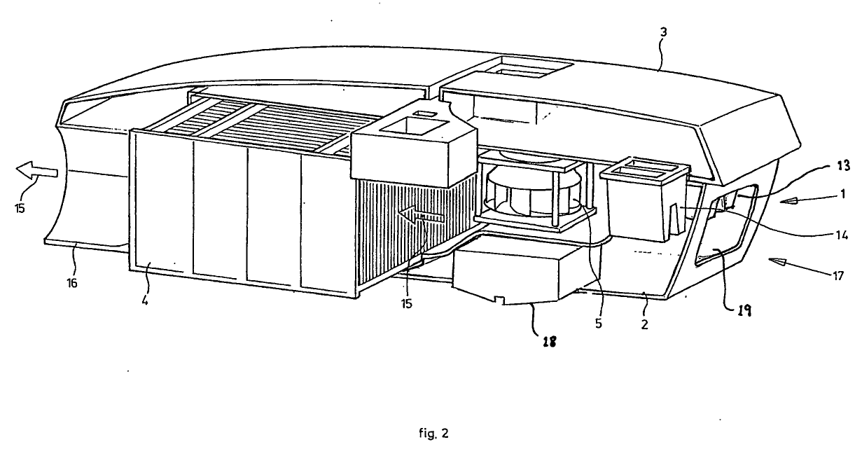

FIG. 2 shows a similar view to FIG. 1 wherein the components are accommodated within the housing; and

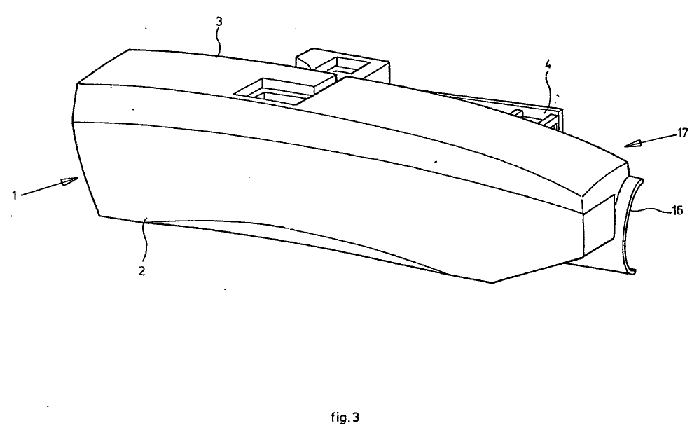

FIG. 3 is a perspective view from the other side in the assembled situation according to FIG. 2.

FIG. 1 shows an housing 1 comprising a bottom 2 and a cover 3 which is connected thereto by means of suitable means, for instance screw connections, snap connections or the like. Both the bottom 2 and cover 3 are formed by rotomoulding and comprise interior cavities. A heat exchanger 4 is located within an interior space formed within the housing 1. The heat exchanger is preferably a dewpoint cooler, i.e. a device able to cool air substantially through use of the heat released during the evaporation of water. In a dewpoint cooler, a stream of air after passing over a first dry side of a heat exchange element is subsequently split into two separate flows. A first part of the flow is output to the space where cooling is required. The second part of the flow is returned over a second moist or wet side of the heat exchanger where it absorbs moisture by evaporation from the surface of the heat exchanger into the airflow. The second part of the flow is maintained separate from the first part of the flow and subsequently exhausted to the environment.

For driving the air flow, use is made of a fan 5 (see also FIG. 2) which, according to FIG. 1, comprises among others the following components: a rotor 6 with blades 7, two frame plates 8, 9 with spacers 10 and stator rings 11, 12. Further accommodated in housing 1 are for instance control elements such as electronic units and air filters 13, 14. Reference is also made in this respect to FIG. 2.

During installation of the components in the housing, further openings may be formed into the hollow cavities of both the bottom 2 and the cover 3. These openings may serve as inlet or outlet openings to the interior of the housing or may serve to install components or wiring etc. within the cavities of the bottom 2 or cover 3. FIG. 2 shows e.g. a water tank 18 located within the cavity of the bottom 2. Furthermore, air filters 13, 14 can be partially located within an opening (not shown) formed in the bottom 2. FIG. 2 also shows clearly the manner in which the airflow generated by fan 5 can be discharged to the outside through the heat exchanger 4 according to an arrow 15 via an air outlet 16. The air inlet to the fan 5 may be provided by an opening 19 formed in the bottom 2.

FIG. 2 and 3 each show one side of a half of a finished air handling unit 17.

1. An air handling unit comprising a housing defining an interior space and a heat exchange element located within the interior space, the housing being provided with an air inlet and an air outlet communicating an exterior of the housing with the interior space, wherein the housing is at least partially formed from plastics material using a rotomoulding technique.

2. The air handling unit according to claim 1, wherein the heat exchange element is an evaporative heat exchanger.

3. The air handling unit according to claim 1 or claim 2 wherein the housing is provided with at least two air outlets for the separate output of two separate air streams from the heat exchange element.

4. The air handling unit according to any preceding claim, wherein the housing is formed of a first housing part and a second housing part, which interact to define the interior space and wherein at least the first housing part is formed by rotomoulding.

5. The air handling unit according to claim 4, wherein the first housing part comprises a cavity.

6. The air handling unit according to claim 5, further comprising an additional component at least partially located within the cavity of the first housing part.

7. The air handling unit according to claim 6, wherein the additional component is a water reservoir.

8. A method for manufacturing a three-dimensional plastic housing or a part thereof for an air handling unit, for instance a heating device, a cooling device, a drying device, a humidifying device, an air-conditioner or the like, wherein the housing is manufactured by rotomoulding in a mould to form a substantially hollow body.

9. The method according to claim 8 comprising:
(a) designing the external form of the housing, optionally subdivided into its constituent parts;
(b) manufacturing a mould with a mould cavity having a form corresponding with said external form, respectively optionally more than one mould, the mould cavity being accessible for admitting plastic and being subsequently closeable;
(c) admitting into the mould cavity a limited quantity of plastic which has been plasticized in advance by heating and/or is plasticized on the heated wall of the mould cavity, the limited quantity being sufficient to form a wall having a chosen thickness;
(d) closing the mould;
(e) setting the mould into a rotating movement, optionally about more than one axis of rotation;
(f) cooling a wall of the mould cavity while continuing the rotating movement, whereby the plastic plasticized by heating solidifies on the mould wall through cooling and thus forms a layer of cured plastic gradually becoming thicker until substantially all plastic introduced into the mould cavity has cured to form the housing for manufacturing, respectively a part thereof;
(g) opening the mould; and
(h) taking out the finished housing respectively a part thereof.

10. The method as claimed in claim 9, further comprising:
(i) successively applying the method according to claim 1 at the design stage, wherein during step (c) different quantities of plastic are admitted each time into the mould cavity; and
(j) technically evaluating the thus obtained housings and choosing the best in accordance with chosen criteria for the definitive series production.

11. The method as claimed in claim 9, comprising:
(k) performing step (c) with PP, PA, PE, or in particular LLDPE, as plastic.

12. A housing for an air handling unit, for instance a heating device, a cooling device, a drying device, a humidifying device, an air-conditioner or the like, manufactured according to the method as claimed in any of claims 9 to 11.

13. A housing as defined in any of claims 1 to 8 or 12 wherein the volume of the housing is more than 15 000 litres.
